(19) United States
(12) Patent Application Publication
(10) Pub. No.: US 2005/0066829 A1
(43) Pub. Date: Mar. 31, 2005

(54) Hinge system for mounting a servo-motor

(76) Inventor: John Cogswell, Arlington Heights, IL (US)

Correspondence Address: WALLENSTEIN WAGNER & ROCKEY, LTD, 311 SOUTH WACKER DRIVE, 53RD FLOOR, CHICAGO, IL, 60606, US

(21) Appl. No.: 10/941,281

(22) Filed: Sep. 15, 2004

Related U.S. Application Data
(60) Provisional application No. 60/506,437, filed on Sep. 26, 2003.

(51) Int. Cl. B41M 1/00

(52) U.S. Cl. 101/368

(57) ABSTRACT

A hinge system for mounting a servo-motor to an apparatus is provided. The hinge system comprises a hinge plate securely connected to the apparatus, a door plate for connection to a servo-motor. A hinge assembly connects the door plate to the hinge plate. The servo-motor is attached to the door plate, and includes a coupling device. The coupling device is provided for operable engagement with a drive train in the apparatus when the door plate is in a closed position. An adapter plate can be connected to the door plate between the door plate and the servo-motor to allow for adjustment of an axis of the servo-motor.

### CROSS-REFERENCE TO RELATED APPLICATIONS

This application claims the benefit of U.S. Provisional Application No. 60/506,437, filed Sep. 26, 2003.

### FEDERALLY SPONSORED RESEARCH OR DEVELOPMENT

Not applicable.

### TECHNICAL FIELD

The present invention generally relates to a servo-motor mounting system, and more particularly, to a hinge assembly for mounting a servo-motor to an apparatus.

### BACKGROUND OF THE INVENTION

Servo-motors have been used for many years to power various types of industrial apparatuses or machinery such as industrial printing presses, converters or the like. Servo-motors have also been used in connection with household machinery, including dishwashers, refrigerators and other similar appliances. In the past, servo-motors have typically been simply mounted to the outside of an apparatus or machine either, directly or via a mounting plate. Examples of such mounting assemblies for securing a servo-motor to an apparatus or machine are depicted in FIGS. 1 and 2.

Such prior servo-motor mounting structures have enjoyed a great deal of success. However, such arrangements have also presented various problems due to particular shortcomings associated with their construction.

In particular, mounting plate assemblies used for securing servo-motors to an apparatus, such as those shown in FIGS. 1 and 2, limit access to components of the apparatus behind the mounting plate assembly. Accordingly, it is necessary to remove the entire servo-motor and the mounting plate assembly in order to service or repair such components. Such service or repair also typically requires disconnecting power and control wiring or cables between the apparatus and the servo-motor. This is because the servo-motor is placed on the ground or otherwise moved a sufficient distance away from the apparatus or machine (i.e., beyond the range of the wiring). In some instances, large servo-motors can weigh in excess of 600 pounds which significantly increases the difficulty and time involved in removing the servo-motor. Moreover, for such large servo-motors, special equipment may be required (as well as ensuring there is enough room to maneuver such equipment) to lift or hold the servo-motor when removing it from the apparatus or machine.

In addition to the problems associated with disconnecting and removing the servo-motor from the apparatus or machine, serious alignment problems are often encountered when remounting the servo-motor back on the apparatus or machine. As such, simple inspections, routine maintenance, replacement or repair of components can be costly and can also result in significant down-time of the apparatus.

The present invention is provided to solve the access and alignment problems discussed above, as well as other problems associated with mounting assemblies used in the past, and to provide advantages and aspects not provided by prior servo-motor and apparatus interfaces. A full discussion of the features and advantages of the present invention is deferred to the following detailed description and claims, which proceeds with reference to the accompanying drawings.

### SUMMARY OF THE INVENTION

The present invention is directed toward a hinge system or assembly for mounting a large servo-motor or drive to an apparatus or machine. The hinge assembly comprises a hinge plate which is securely attached to the housing of the apparatus or machine. The hinge assembly further comprises a door plate configured for hingeable attachment to the hinge plate connected to the machine housing. The door plate is designed to allow the servo-motor to be secured to the door plate and further includes one or more openings to allow for various connections between the servo-motor and components in the apparatus or machine. In one embodiment, the servo-motor includes a coupling device for operable engagement with a power or drive system associated with the apparatus or machine when the door plate is in a closed position. In some instances (e.g., in the absence of a drive train), the servo-motor can be connected directly to a rotating element, such as a cylinder or roller, or other similar component in the apparatus or machine.

According to one aspect of the present invention the hinge system described above further comprises an adapter plate disposed between the door plate and the servo-motor. The adapter plate is provided with an adjustable means, such as adjustable screw blocks for adjusting the axial position of the servo-motor relative to corresponding components of the power or drive system in the apparatus or machine. In an alternative embodiment, the adjustable means can be provided directly on the door plate.

According to another aspect of the present invention a power system utilizing a servo-motor is provided. The power system comprises a housing having a plurality of side walls and a back plate. A drive train is disposed in the housing. The power system also includes a door plate hingeably attached to the housing. The door plate is movable between an open position and a closed position. The power system further includes a servo-motor attached to the door plate. The servo-motor has a coupling device provided for operable engagement with the drive train. When the door plate is in the closed position, the coupling device can operably engage the drive train. Conversely, when the door plate is in the open position, the coupling device is disengaged from the drive train.

In another embodiment of the invention, a hinge system for mounting a servo-motor to an apparatus comprises a door plate having a opening therethrough. The door plate is configured for hingeable attachment to a housing of the apparatus. A servo-motor is connected to the door plate, the servo-motor including a coupling device provided for operable engagement with components of the apparatus when the door plate is in a closed position, wherein at least a portion of the coupling device extends through the opening in the door plate.

The hinge system can further include a hinge plate connected to the apparatus. The hinge plate is further connected to the door plate via a hinge assembly. The hinge assembly can include corresponding bosses on the hinge plate and door plate, and a hinge pin disposed within the bosses In an alternative embodiment, the door plate can be connected directly to the housing of the apparatus without the need of a hinge plate. In this embodiment, the housing can be custom designed to include appropriate bosses for a hingeable connection to the door plate (in other words, the side wall of the housing acts as the hinge plate).

The hinge system can further include an adapter plate connected to the door plate and disposed between the door plate and the servo-motor. The adapter plate can comprise a means for adjusting an axial position of the servo-motor to properly align the servo-motor with components of the apparatus (e.g., a drive train). The adjusting means can be a plurality of adjustable screw blocks connecting the adapter plate to the servo-motor.

The hinge system can comprise one or more needle bearings for receipt of radial loads disposed in the hinge assembly. The hinge system can also comprise one or more thrust bearings for receipt of axial loads disposed in the hinge assembly.

In another embodiment of the invention, a hinge system for mounting a motor to an apparatus comprises a hinge plate securable to a housing of an apparatus, the hinge plate having at least one boss extending outward from the hinge plate, and a door plate connected to the hinge plate, the door plate having at least one boss extending outward from the door plate, the door plate securable to a motor. Additionally, the hinge system includes a hinge pin positioned within the at least one boss of the hinge plate and the at least one boss of the door plate.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a schematic cross-sectional view of a prior art mounting plate for securing a servo-motor to an apparatus;

FIG. 2 is a schematic top elevation view of the prior art mounting plate and servo-motor of FIG. 1;

FIG. 3 is a front perspective view of a servo motor mounted to an apparatus by a hinge system in accordance with the present invention;

FIG. 4 is a cross-sectional view of the hinge system of FIG. 3 of the present invention as taken through line 4-4;

FIG. 5 is a cross-sectional view of the hinge system of FIG. 3 of the present invention as taken through line 5-5;

FIG. 6 is a partial side view of the hinge system of the present invention shown in FIG. 3;

FIG. 7 is a top elevation view of an adaptor plate for use with the hinge system of the present invention;

FIG. 8 is a top elevation view of a door plate for use with the hinge system of the present invention;

FIG. 9 is a top elevation view of a hinge plate for use with the hinge system of the present invention;

FIG. 10 is a perspective view of the hinge system of the present invention with the door plate in a closed position; and,

FIG. 11 is a perspective view of the hinge system of FIG. 10 with the door plate in an open position.

### DETAILED DESCRIPTION

While this invention is susceptible to embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

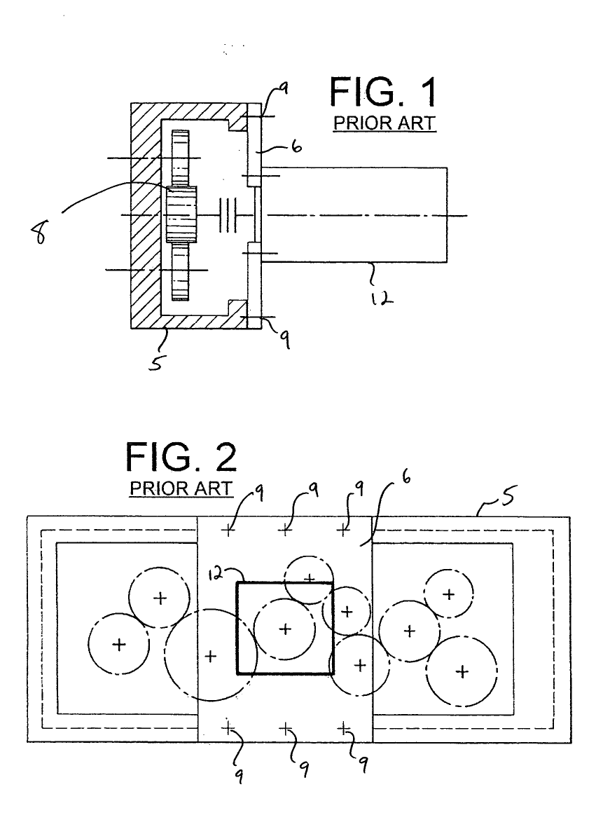

As shown in FIGS. 1 and 2, a large servo-motor 12 is typically connected to an apparatus 5 by a mounting plate 6. As illustrated in FIG. 1, the servo-motor 12 is aligned with and operatively coupled to a drive train 8 in the apparatus 5. The drive train 8, in turn, is operatively coupled to other components in the apparatus 5.

The mounting plate 6 is securely attached to the housing of the apparatus 5 by a plurality of bolts 9. Similarly, the servo-motor 12 is securely connected to the mounting plating 6.

The presence of the servo-motor 12, makes it difficult to obtain access to the components of the apparatus behind the mounting plate 6. In order to inspect, service or repair such components it is necessary to completely remove the mounting plate 6 and servo-motor 12 from the apparatus 5. This can be time consuming and may require special equipment to lift or hold the servo-motor 12 (e.g., in the case of a large or heavy motor). Additionally, it is often necessary to disconnect any wiring or cables between the servo-motor and the apparatus or machine when removing the servo-motor for inspection, servicing or repair of the components of the apparatus on the other side of the mounting plate 6. The wiring or cables must be reconnected when remounting the servo-motor 12 to the apparatus 5, which adds to the downtime of the apparatus.

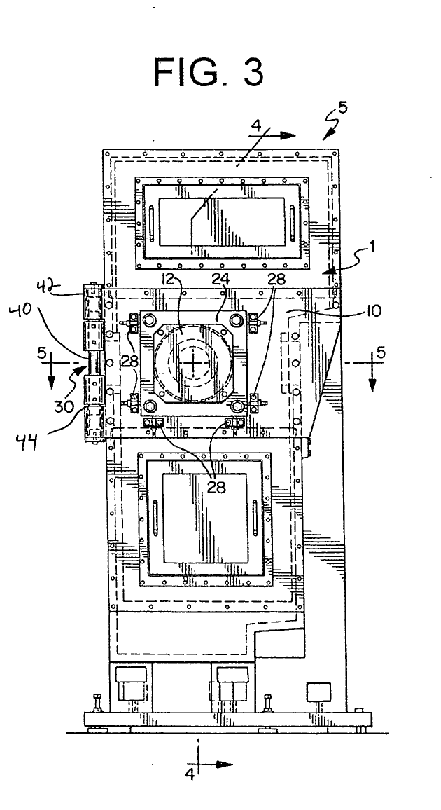

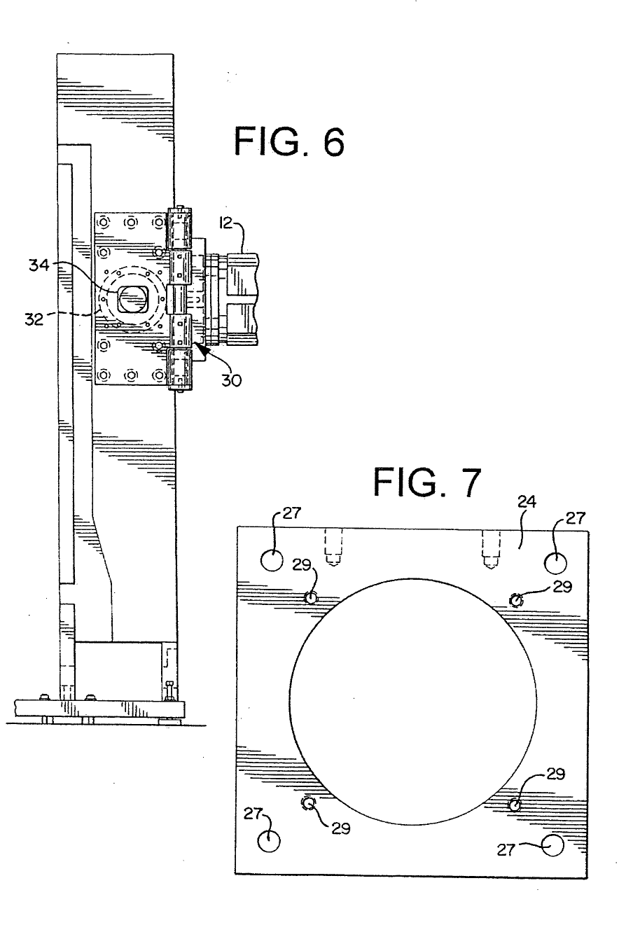

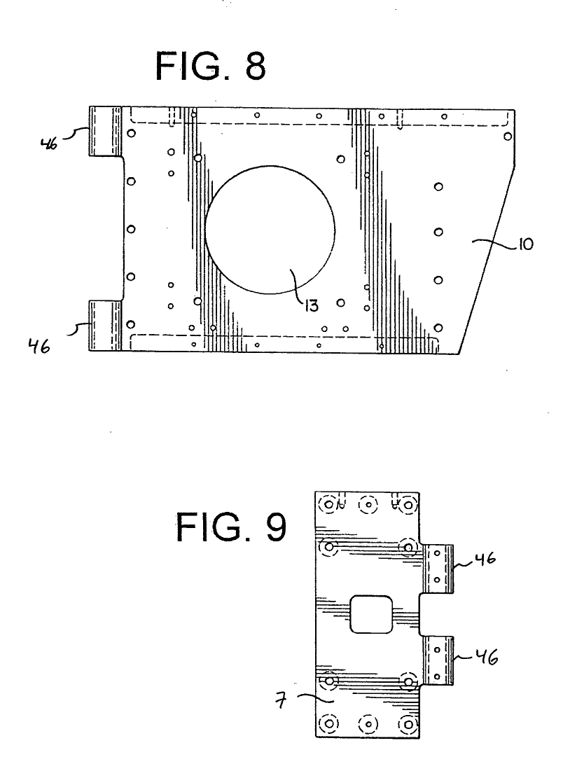

Referring now in detail to the FIGS. 3-9, a hinge system 1 for mounting a servo-motor assembly 12 to an apparatus 5 is provided. According to the present invention, the servo-motor 12 may be coupled, axis to axis, to a power train assembly (e.g., drive train 14) or other components within the apparatus 5. The apparatus 5 may be any type of machine or machine component that utilizes a servo-motor 12. For example, according to one embodiment of the present invention, the hinge system 1 for mounting the servo-motor assembly 12 is used in connection with a printing press.

As shown in FIGS. 3-6, the hinge system 1 for mounting the servo-motor assembly 12 to the apparatus 5 includes a hinge plate 7 which is securely fastened to a wall or panel of the apparatus 5 by a plurality of heavy duty bolts or screws 8. The hinge system 1 also includes a door plate 10 which is attached to the hinge plate 7 by a precision hinge as described in more detail below. A servo-motor 12 is attached to the door plate 10.

The door plate 10 includes a central opening 13 through which at least some of the functional components of the servo-motor 12 may pass for engagement with the power system 14 or other corresponding components in the apparatus 5. For example, the servo-motor 12 can include a coupling device 16 provided for operable engagement with the power system 14 in the apparatus 5.

As shown in FIGS. 3-5, the power system generally comprises a housing 18 in which a drive train 14 or similar power train is disposed. The housing 18 is comprised of a plurality of side walls 20 and a back plate 22.

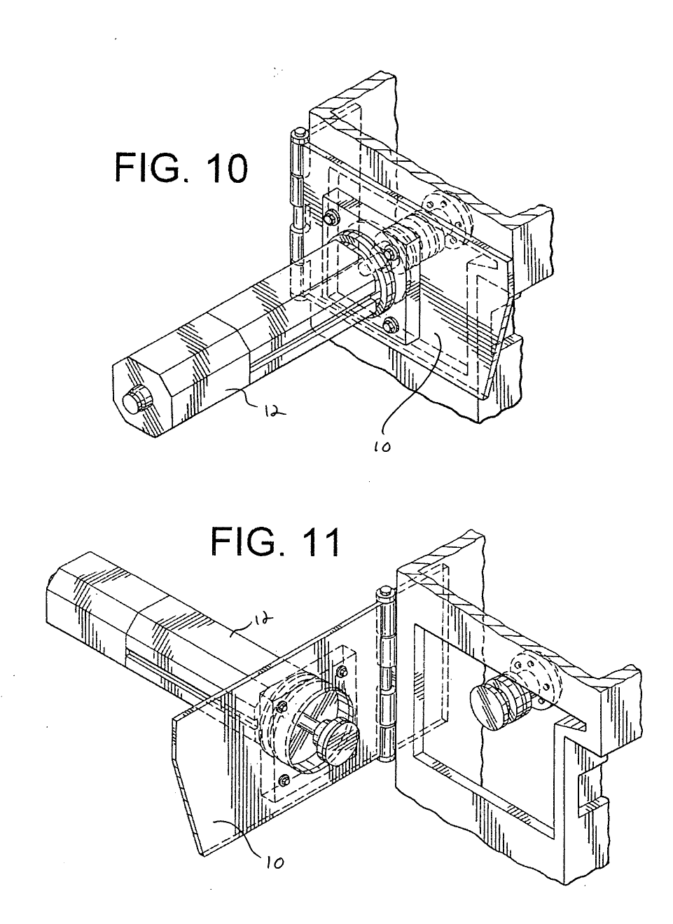

The door plate 10 of the hinge system 1 is hingeably attached to the hinge plate 7 which is secured to the power train housing 18. When assembled, the door plate 10 is movable between an open position and a closed position and shown in FIGS. 10 and 11.

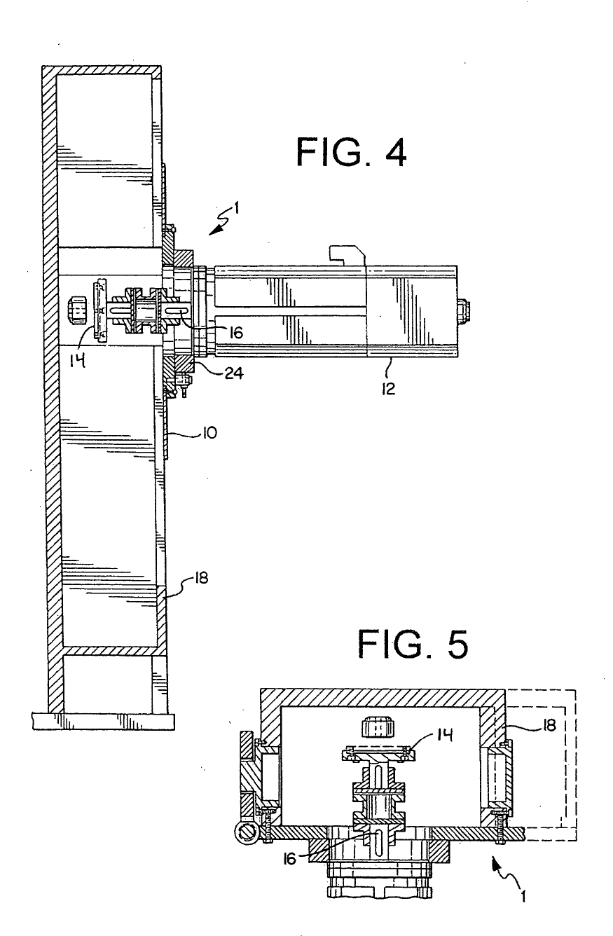

As illustrated in FIGS. 4 and 5, when the door plate 10 is in the closed position, the coupling device 16 operably engages the drive train 14 of the apparatus 5. Conversely, when the door plate 10 is in the open position the coupling device 16 is disengaged from the drive train 14. The hinge plate 7 and the door plate 10 are preferably made from 1015-1020 hardened steel. The housing 18 may be manufactured of any material suitable for mounting a servo-motor 12.

In one preferred embodiment of the present invention shown in FIG. 7, the hinge system 1 further comprises an adapter plate 24 having a central opening 25 over which the servo-motor 12 may be secured. Like the hinge plate 7 and the door plate 10, the adapter plate 24 is preferably made from 1015-1020 hardened steel.

The adapter plate 24 is securely connected to the outer side of the door plate 10, between the door plate 10 and the servo-motor 12, and is configured in such a manner that the servo-motor 12 is attached to the outer surface of the adapter plate 24.

As shown in FIG. 7, the adapter plate 24 includes a plurality of apertures 27 proximate each corner for receiving fasteners for securable attachment of the adapter plate 24 to the door plate 10. The adapter plate 24 also includes a second plurality of apertures 29 proximate the central opening 25. This second plurality of apertures 29 accommodate fasteners for attachment of the servo-motor 12 to the adapter plate 24.

The adapter plate 24 also provides a means 26 for adjusting the axial position of the servo-motor 12 to match that of the mating drive train 14 components. In particular, the adapter plate 24 of the present invention is meant to alleviate the necessity for a precise location of the door plate 10 during assembly. In this manner, the addition of the adapter plate 24 assists in reducing assembly and set-up time of the hinge system 1. The specific mechanisms that may be employed to adjust the axial position of the servo-motor 12 are discussed in further detail below. The adapter plate 24 and door plate 10 as utilized with the present hinge system 1 provides a faster and safer means to displace the servo-motor 12 and to accurately return it to its operating position as compared to prior servo-motor 12 mounting structures.

Specifically, the adjusting means 26 enables an operator to adjust the axial position of the servo-motor 12 relative to corresponding components of the power train 14. In a preferred embodiment shown in FIG. 3, the adjusting means 26 comprises one or more adjustable screw blocks 28. It is contemplated, however, that the adjusting means 26 may also be a hydraulic or a pneumatic piston system, a pin and bearing assembly or any suitable mechanism for axially adjusting the servo-motor 12. The adjusting means 26 can be manually operable or may operate in response to an electronic control stimulus without departing from the present invention.

The door plate 10 of the present invention is attached to the hinge plate 7 (which is secured to the housing 18 of the apparatus 5) via a precision hinge assembly 30. In a preferred embodiment, the hinge assembly 30 is comprised of a hardened hinge pin 40 that passes through corresponding bosses 46 on the hinge plate 7 and the door plate 10. It is preferable that the hinge assembly 30 of the present invention incorporate needle bearings 42 for receiving radial loads and thrust bearings 44 to receive axial loads.

The hinge system 1 can include a pilot or other guiding means to assist in aligning the door plate 10 and servo-motor 12 when positioning the servo-motor 12 in place against the apparatus 5. Additionally, in order to initially locate the hinge system 1 on the apparatus 5, the hinge plate 7 may include a bore 32 adapted to receive a plug or stopper 34 on the housing 18 of the apparatus 5. This bore 32 and stopper 34 arrangement assists the user during assembly to locate the hinge system 1 in the proper location. As with many of the arrangements of the present invention, the bore 32 and stopper 34 allow a user to install and precisely position the servo-motor 12 with the accuracy required for coupled or belt drive connections.

In operation, the hinge system 1 allows the servo-motor 12 to swing outwardly from the apparatus 5 to provide easy access to the components of the apparatus 5 on the other side of the door plate 10 without fully removing the servo-motor 12 from the apparatus. Once access to such components is no longer needed, the hinge system 1 allows the servo-motor 12 to swing back into position on the outside of the apparatus 5. Because the servo-motor 12 is not completely removed from the apparatus 5 (i.e., the servo-motor 12 remains connected to the door plate 10 which is attached to the press by the hinge assembly 30) power and control wiring or cables between the apparatus 5 and the servo-motor 12 do not necessarily need to be disconnected. Moreover, a forklift, winch or other machine is not needed to lift the servo-motor 12 (as may be in the case of a servo-motor mounted to the apparatus 5 by only a mounting plate). This allows for a reduced down time when inspecting, servicing or repairing the components in the apparatus behind the door plate 10 of the hinge system 1.

While the specific embodiments have been illustrated and described, numerous modifications come to mind without significantly departing from the spirit of the invention, and the scope of protection is only limited by the scope of the accompanying Claims.

1. A hinge system for mounting a servo-motor to an apparatus comprising:
a door plate having a opening therethrough, the door plate configured for hingeable attachment to a housing of the apparatus; and,
a servo-motor connected to the door plate, the servo-motor including a coupling device provided for operable engagement with components of the apparatus when the door plate is in a closed position, wherein at least a portion of the coupling device extends through the opening in the door plate.

2. The hinge system of claim 1 further comprising a hinge plate connected to the apparatus and to the door plate.

3. The hinge system of claim 1 further comprising an adapter plate disposed between the door plate and the servo-motor.

4. The hinge system of claim 2 wherein the adapter plate comprises adjusting means for adjusting an axial position of the servo-motor relative to the components in the apparatus to align the servo-motor with the components.

5. The hinge system of claim 4, wherein the adjusting means comprise a plurality of adjustable screw blocks.

6. A mounting system for mounting a servo-motor to an apparatus, the mounting system comprising:
a door plate configured for hingeable attachment to an apparatus, the door plate including and opening therein for passage of at least a portion of a servo-motor coupling device therethrough; and,
a precision hinge assembly for connecting the door plate to a portion of an apparatus.

7. The mounting system of claim 6, wherein the precision hinge assembly comprises a hardened hinge pin.

8. The mounting system of claim 6, wherein the precision hinge assembly comprises at least one needle bearing for receipt of radial loads.

9. The mounting system of claim 6, wherein the hinge assembly comprises at least one thrust bearing for receipt of axial loads.

10. The mounting system of claim 6, further comprising an adapter plate attached to the door plate and having a central opening therein, the adapter plate being adapted to be disposed between the door plate and a servo-motor.

11. The mounting system of claim 10, wherein the adapter plate comprises adjusting means for adjusting an axial position of the servo-motor to align the servo-motor with components in the apparatus.

12. The mounting system of claim 11, wherein the adjusting means comprise a plurality of adjustable screw blocks.

13. The mounting system of claim 6, wherein the hinge assembly is adapted to receive a flange extending from the housing.

14. The mounting system of claim 6, further comprising a hinge plate connected to the housing and to the door plate.

15. The system of claim 6, wherein the apparatus is a printing press.

16. A hinge system for mounting a servo-motor assembly comprising:
a hinge plate securable to a housing of an apparatus, the hinge plate having at least one boss extending outward from the hinge plate;
a door plate connected to the hinge plate, the door plate having at least one boss extending outward from the door plate, the door plate securable to a motor; and,
a hinge pin positioned within the at least one boss of the hinge plate and the at least one boss of the door plate.

17. The hinge system of claim 16 further comprising:
ad adapter plate secured to the door plate, the adapter plate securable to the motor.

18. The hinge system of claim 17 wherein the adapter plate includes means for adjusting the axial position of the motor to align the motor with components in the apparatus.

19. The hinge system of claim 18 wherein the adjusting means comprises a plurality of adjustable screw blocks connected to the adapter plate.

20. The hinge system of claim 16 further comprising:
at least one needle bearing disposed in one of the boss extending from the hinge plate and the boss extending from the door plate, and,
at least one thrust bearing disposed in one of the boss extending from the hinge plate and the boss extending from the door plate.
